(19) United States
(12) Patent Application Publication
(10) Pub. No.: US 2005/0255436 A1
(43) Pub. Date: Nov. 17, 2005

(54) Learning methods employing multiple sensory pathways

(76) Inventor: Richard D. Thwaites, Grapevine, TX (US)

Correspondence Address: MONIQUE A. VANDER MOLEN;GARDERE WYNNE SEWELL LLP, 1601 ELM STREET, SUITE 3000, 3000 THANKSGIVING TOWER, DALLAS, TX, 75201, US

(21) Appl. No.: 11/127,356

(22) Filed: May 12, 2005

Related U.S. Application Data
(60) Provisional application No. 60/570,613, filed on May 12, 2004.

(51) Int. Cl. G09B 5/00; G09B 3/00; G09B 7/00

(52) U.S. Cl. 434/308; 434/322

(57) ABSTRACT

The present invention includes methods of learning material. The methods apply the stimulations of multiple sensory pathways simultaneously. The sensory stimulations include auditory, visual, tactile, and combinations thereof. The method includes listening to material to be learned while simultaneously reading the material to be learned and may be repeated as often as required in order for the material to be learned. Preferably, the simultaneous stimulation relies on the use of the auditory cortex and the visual cortex in order to form memory.

### CROSS-REFERENCE TO RELATED APPLICATION

This application claims the benefit of U.S. Provisional Patent Application No. 60/571,613 filed May 12, 2004.

### BACKGROUND OF THE INVENTION

The present invention relates to methods of learning, particularly ones for learning new material.

Learning of material remains a challenge for many individuals, despite the number of available programs deigned to increase learning and/or improve retention and understanding of material. Accordingly, there remains a need for effective methods that improve learning, retention and understanding of new or updated material.

### SUMMARY OF THE INVENTION

The present invention solves many problems associated with the inability of one to learn material.

Generally, and in one form of the present invention is a method of applying multiple sensory stimulations of the same information simultaneously. The sensory stimulations include auditory, visual, tactile, and combinations thereof.

The present invention provides for a method of learning material comprising listening to material to be learned while simultaneously reading the material to be learned. This method may be repeated as often as required in order for the material to be learned. For the present invention, the method relies on the simultaneous use of the auditory cortex and the visual cortex in order to form memory and to learn the material. The method provides for the formation of new synaptic processes (synapses) in the brain which are involved in the learning process.

In another form, the present invention is also a method comprising the steps of obtaining material, making a first recording of the material, reviewing the material, identifying important content of the material, highlighting the important content, making a second recording of the material and reviewing to the first and second recording of the material at the same time. The recording may be written, auditory, visual, and combinations thereof (including their equivalents). Typically, the first recording differs from the second recording in order to for there to be a simultaneous use of the auditory cortex and the visual cortex. Importantly, the method improves memorization of the material.

In yet another form, the method includes obtaining material, reviewing the material, identifying important content in the material, making a recording of the important content of the material; and reviewing the recording while reviewing the important content at the same time. The material may include one or more questions for answering. The step of reviewing the material includes one or a number of steps, including answering questions in the material, identifying incorrect answers to questions, highlighting the material related to the incorrect answers, reviewing the highlighted material, reviewing the important content and combinations thereof. The recording may be written, auditory, visual, and combinations thereof (including their equivalents). When the recording is review at the same time the material is reviewed, there is simultaneous stimulation of the auditory cortex and the visual cortex. Accordingly, the method improves memorization of the material.

Those skilled in the art will further appreciate the above-noted features and advantages of the invention together with other important aspects thereof upon reading the detailed description that follows in conjunction with the drawings.

### BRIEF DESCRIPTION OF SEVERAL VIEWS OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 depicts a flowchart in accordance with one aspect of the present invention;

FIG. 2 depicts a flowchart in accordance with another aspect of the present invention; and

FIG. 3 depicts a flowchart in accordance with yet another aspect of the present invention.

### DETAILED DESCRIPTION

Although making and using various embodiments of the present invention are discussed in detail below, it should be appreciated that the present invention provides many inventive concepts that may be embodied in a wide variety of contexts. The specific aspects and embodiments discussed herein are merely illustrative of ways to make and use the invention, and do not limit the scope of the invention.

In the description which follows like parts may be marked throughout the specification and drawing with the same reference numerals, respectively. The drawing figures are not necessarily to scale and certain features may be shown exaggerated in scale or in somewhat generalized or schematic form in the interest of clarity and conciseness.

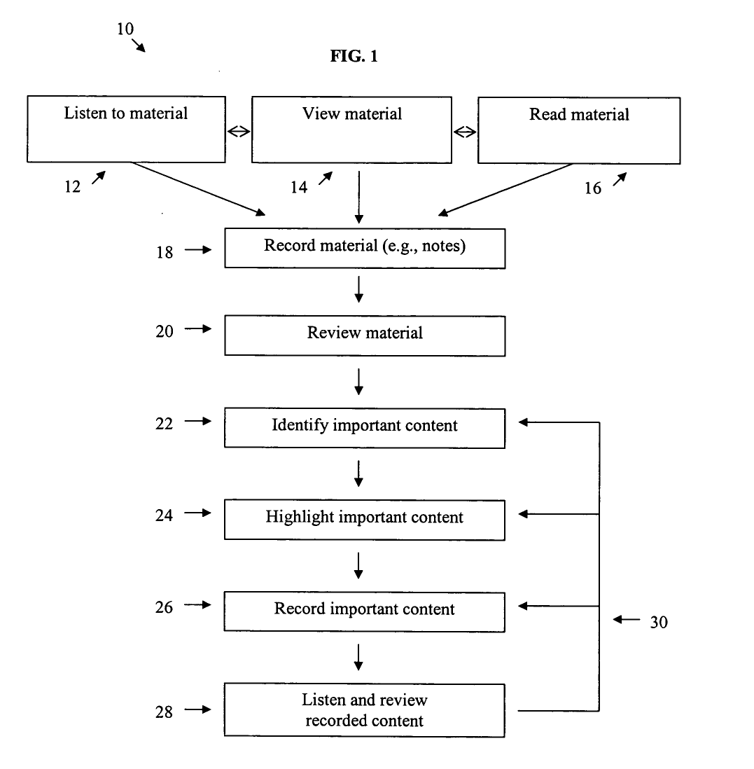

Referring to FIG. 1 is flowchart 10 showing a representative example of the method for learning, retaining, and/or understanding material. The initial elements of the method include listening to the material (box 12), viewing the material 14 (box 14), and/or reading the material (box 16). The material may be in the form of a visual presentation or context, auditory presentation or context, written presentation or context, and combinations thereof, such that the written context may include examinations, tests, memorandums, books, magazines, articles, and equivalents. Accordingly, any combination of boxes 12, 14, and 16 may be used to initiate the method of the present invention. Subsequently, the material is made into a first record, for example via any of a combination of tapes, notes, memos, outlines, and their equivalents (box 18). This is followed by reviewing the material (box 20) and identifying material considered important, difficult (box 22), to be retained, understood and/or learned. This is also referred to as important or identified material.

After identifying important content of the material, the important material is highlighted (box 24). In some instances, highlighting may include re-recording the important content using the examples previously provided and their equivalents. After highlighting, the important material is made into a second record (box 26). This may include dictating into a recording device that also allows the important material to be listened to at a later date, or using any of the methods of recording previously discussed for box 18.

The important recorded material is then listened to and reviewed at the same time (box 28). Accordingly, the material is read and listened to simultaneously. Thus, there is simultaneous use of the auditory cortex and visual cortex in order to learn the identified material. The entire process or parts of the process may be repeated as many times as required. For example, certain material may be re-identified, re-highlighted, and/or re-recorded as needed. This repetition may be used to refine the learning, improve learning, identify new material to be learned, and/or focus on material that is difficult or not yet learned. The recorded content may also be listened to independent of reviewing it. In addition, the process may be performed by an individual and/or a group.

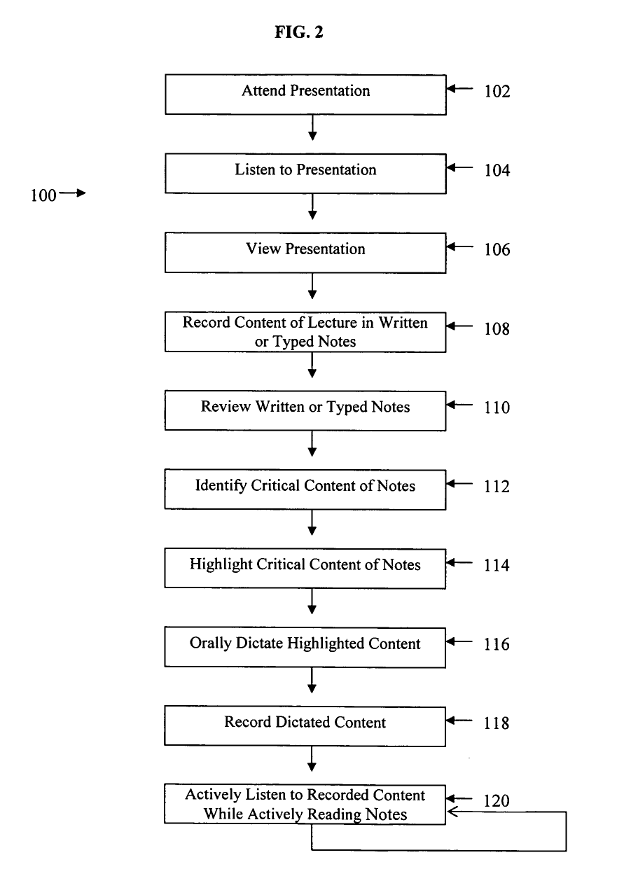

FIG. 2 depicts, in flowchart 100, another embodiment of the present invention. According to this embodiment, a presentation is attended, as shown in box 102. During the presentation, the presentation is listened to (104), viewed (106) and the content of the presentation recorded (e.g., written notes, typed notes, etc.) (108). Subsequent to the presentation, the notes are reviewed (110) and material perceived to be important or difficult is identified (112).

In some instances, there is a focus on discrete portions of information at a time, on the order of one or two pages. In this form, important and/or difficult material is highlighted (114) and the highlighted material is orally dictated (116) and recorded (118) into a recording device (e.g., audio recording device or an equivalent). After this process is complete, there is an audio recording of the highlighted material. The audio recording will vary in length depending on the volume of highlighted material.

After the audio recording is created (e.g., in steps 102-118), the audio recording is actively listened to while there is a simultaneously and active reading of notes (120). The listening and rereading step identified in box 120 may be repeated once or multiple times, as necessary. Employed in this manner, the auditory cortex and visual cortex of the brain are used on the same material simultaneously. Memories are made by synaptic processes. Accordingly, the present invention forms such synaptic processes in the brain in order. Memory is thus formed and the material is learned (i.e., remembered).

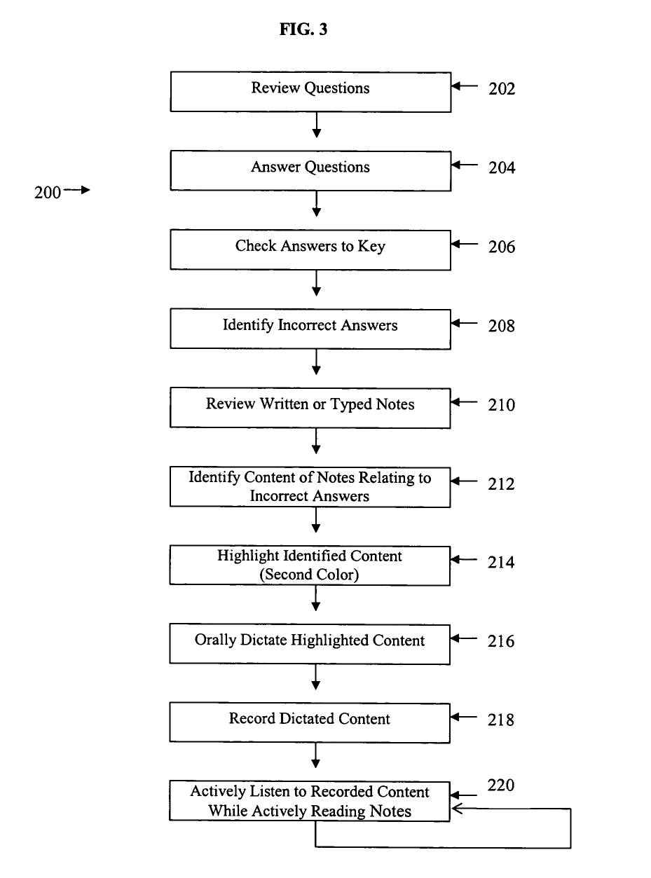

Subsequent to the first phase of the above-described method, a second phase may be employed to reinforce the memories created according to the first method. The second phase is shown in FIG. 3 in flowchart 200. According to this phase, the questions (202) in a sample examination are reviewed. The questions (204) are then answered according to the understanding of the material studied using the first phase of the method depicted in FIG. 1 or FIG. 2. After one or more questions are answered, the answers are compared (206) to a key. Incorrect answers are then identified (208) and the recorded material is reviewed (210). The material relating to the incorrect answers is then identified (212) and highlighted (214), in either the same color, or a different color, as the original highlighting was performed in box 24 of FIG. 1 or box 114 of FIG. 2. In a similar manner as that shown in FIG. 1 or FIG. 2, the highlighted material is then dictated (216), the dictated content is recorded (218) using a device, such as an audio recording device or an equivalent, and the device is replayed while the identified material is reread (220). The process of box 220, as well as the process outlined in flowchart 200, may be repeated as many times as necessary in order to reinforce the desired memory pathways. As before, these processes may be performed by an individual and/or a group. The recorded content may also be listened to independent of reviewing it.

Additional objects, advantages and novel features of the invention as set forth in the description, will be apparent to one skilled in the art after reading the foregoing detailed description or may be learned by practice of the invention. The objects and advantages of the invention may be realized and attained by means of the instruments and combinations particularly pointed out here.

1. A method of learning material comprising the steps of:
listening to material to be learned while simultaneously reading the material to be learned.

2. The method of claim 1, wherein the method is repeated until the material is learned.

3. The method of claim 1, wherein the material is visual, auditory, written, and combinations thereof.

4. The method of claim 1, wherein the method simultaneously uses the auditory cortex and visual cortex in order to form memory and to learn the material.

5. The method of claim 4, wherein the method improves memorization of the material.

6. A method of learning material comprising the steps of:
obtaining material;
making a first recording of the material;
identifying important content of the material;
making a second recording of the material; and
reviewing the first and second recording of the material at the same time.

7. The method of claim 6, wherein the material obtained is visual, auditory, written, and combinations thereof.

8. The method of claim 6, wherein the first recording and second recording are selected from the group consisting of written, auditory, visual, and combinations thereof, the first recording and second recording being different from each other.

9. The method of claim 6, wherein the first recording is written.

10. The method of claim 6, wherein the second recording is auditory.

11. The method of claim 6, wherein all or a portion of the steps are repeated until the material is learned.

12. The method of claim 6, wherein the step of reviewing simultaneously uses the auditory cortex and the visual cortex.

13. The method of claim 6, wherein the method improves memorization of the material.

14. The method of claim 6, wherein identifying is selected from the group consisting of highlighting the important content, reviewing the important content, reviewing highlighted content, and combinations thereof.

15. A method of learning material comprising the steps of:
obtaining material;
reviewing the material;
identifying important content in the material;
making a recording of the important content of the material; and
reviewing the recording while reviewing the important content at the same time.

16. The method of claim 15, wherein the material obtained is visual, auditory, written, and combinations thereof.

17. The method of claim 15, wherein the recording is selected from the group consisting of written, auditory, visual, and combinations thereof.

18. The method of claim 15, wherein all or a portion of the steps are repeated until the material is learned.

19. The method of claim 15, wherein the step of reviewing simultaneously uses the auditory cortex and the visual cortex.

20. The method of claim 15, wherein the material has one or more questions for answering.

21. The method of claim 15, wherein the step of reviewing the material includes answering questions in the material, identifying incorrect answers to questions, highlighting the material related to the incorrect answers, reviewing the highlighted material, reviewing the important content and combinations thereof.
